(19) United States
(12) Patent Application Publication
(10) Pub. No.: US 2014/0088783 A1
(43) Pub. Date: Mar. 27, 2014

(54) SYSTEM FOR THE DELIVERY OF ELECTRICAL ENERGY, AND METHOD FOR THE DELIVERY OF ELECTRICAL ENERGY, PROGRAM, AND COMPUTER PROGRAM PRODUCT

(71) Applicant: Matthias Roebke, Cologne (DE)

(72) Inventor: Matthias Roebke, Cologne (DE)

(73) Assignee: DEUTSCHE TELEKOM AG, Bonn (DE)

(21) Appl. No.: 14/116,792

(22) PCT Filed: May 9, 2012
(86) PCT No.: PCT/EP2012/001985

§ 371 Date: Nov. 11, 2013

(30) Foreign Application Priority Data
May 11, 2011 (EP) 11003850.2

(51) Int. Cl. H02J 4/00

(52) U.S. Cl. CPC H02J 4/00
USPC 700/295

(57) ABSTRACT

A system for delivery of electrical energy includes a first electrical power distribution station assigned a first electrical power distribution identifier and a second electrical power distribution station assigned a second electrical power distribution identifier. An electrical power distribution control entity is configured to receive, when electrical power is requested from the first electrical power distribution station, the first electrical power distribution identifier and power request identifier, and configured to receive, when electrical power is requested from the second electrical power distribution station, the second electrical power distribution identifier and the power request identifier. The power request identifier is assigned a user or a group of users and/or a device configured to require or provide electrical power.

### CROSS-REFERENCE TO RELATED APPLICATIONS

This application is a U.S. National Phase application under 35 U.S.C. §371 of International Application No. PCT/EP2012/001985, filed on May 9, 2012, and claims benefit to European Patent Application No. EP 11003850.2, filed on May 11, 2011. The International Application was published in English on Nov. 15, 2012, as WO 2012/152436 A1 under PCT Article 21(2).

### FIELD

The present invention relates to a system for the delivery of electrical energy. Furthermore, the present invention relates to a method for the delivery of electrical energy, to a program, and to a computer program product.

### BACKGROUND

Distribution and use of electrical energy is requested by a user or by a group of users, and the electrical energy is consumed by a device requiring or providing electrical power such as a washing machine or a refrigerator or a charging device for a mobile phone or a mobile computer or the batteries of an electrical vehicle.

At least some conventional systems enable roaming capabilities for use of mobile communications systems. More specifically, a communication device, such as a mobile phone, is configured for a network operated by a specific operator, and when the mobile phone is used outside of that network the outside provider bills the specific operator for its customer's usage and the specific operator would then bill its customer for the roaming usage, usually including an additional fee for the benefit of roaming. Such systems are intended for roaming of a mobile phone for communications purposes.

Roaming capabilities in mobile communication networks enable the so-called nomadic usage of mobile communication services, e.g. the user of a first public land mobile network in a specific geographic area where the first public land mobile network does not have a genuine coverage but where an agreement (as well as technical capabilities) exist between the operator of the first public land mobile network and an operator of a second public land mobile network (providing genuine network coverage in the specific geographic area) such that the use of the first public land mobile network is enabled by technically using the infrastructure of the second public land mobile network in the specific geographic area.

Conventional systems lack a power request identifier assigned to at least one out of a user or a group of users, and a device requiring or providing electrical power, wherein an electrical power distribution control entity is flexibly used to provide for the distribution of the requested electrical energy.

### SUMMARY

In an embodiment, the present invention provides a system for delivery of electrical energy. The system includes a first electrical power distribution station assigned a first electrical power distribution identifier; a second electrical power distribution station assigned a second electrical power distribution identifier; and an electrical power distribution control entity, configured to receive, when electrical power is requested from the first electrical power distribution station, the first electrical power distribution identifier and power request identifier, and configured to receive, when electrical power is requested from the second electrical power distribution station, the second electrical power distribution identifier and the power request identifier. The power request identifier is assigned to at least one of: a user or group of users, and a device configured to require or provide electrical power.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a system according to an embodiment of the present invention.

FIG. 2 schematically illustrates the interworking of different electrical power providers by using a broker functionality.

### DETAILED DESCRIPTION

The present invention simplifies the nomadic use of electrical energy and flexibly provides the possibility to request, use, store and meter electrical energy in a convenient manner.

The present invention provides a system for the delivery of electrical energy such that both the convenience for a user requesting or providing electrical energy is enhanced and at the same time the overall costs for providing the electrical energy reduced. Furthermore, the present invention provides a method for the delivery of electrical energy.

The present invention provides a system for the delivery of electrical energy, the system comprising at least a first electrical power distribution station, and a second electrical power distribution station,

wherein a first electrical power distribution identifier is assigned to the first electrical power distribution station, and wherein a second electrical power distribution identifier is assigned to the second electrical power distribution station,
wherein a power request identifier is assigned to at least one out of
a user or a group of users, and
a device requiring or providing electrical power
   wherein the system comprises an electrical power distribution control entity,
   wherein in any case that electrical power is requested from the first electrical power distribution station, the first electrical power distribution identifier and the power request identifier are transmitted to the electrical power distribution control entity, and
   wherein in case that electrical power is requested from the second electrical power distribution station, the second electrical power distribution identifier and the power request identifier are transmitted to the electrical power distribution control entity.

According to the present invention, it is thereby advantageously possible to flexibly use electrical energy independently from the location of usage of the electrical power. This is because in case that electrical power is requested from the first electrical power distribution station, the first electrical power distribution identifier and the power request identifier are transmitted to the electrical power distribution control entity such that it is known to the electrical power distribution control entity that electrical power is consumed at the first electrical power distribution station, whereas in case that electrical power is requested from the second electrical power distribution station, the second electrical power distribution identifier and the power request identifier are transmitted to the electrical power distribution control entity such that it is known to the electrical power distribution control entity that electrical power is consumed at the first electrical power distribution station. It is therefore possible for a user to consume electrical power, e.g., away from his home and nevertheless a billing and a metering functionality can be executed with regard to such a power consumption. This means that according to the present invention, it is advantageously possible to either realize:
an “external roaming” functionality, i.e. a user can use electrical power in relation to an electrical power distribution station that is primarily linked to or related to a different electrical power provider than the electrical power provider usually used by the user, or
an “internal roaming” functionality, i.e. a user can use electrical power in relation to an electrical power distribution station that is primarily linked to or related to a different user than the user requesting electrical power, but the electrical power distribution station is linked to or related to the same electrical power provider of the user.

In summary, the present invention does not correspond to a standard electricity network in which a user can, e.g., sign a contract by using a third party. This is because in each and any case that electrical power is requested from the first/second electrical power distribution station, both
the first/second electrical power distribution identifier and
the power request identifier (which is related to a user or a group of users or to a device requiring or providing electrical power)
   are transmitted to the electrical power distribution control entity. As a consequence, it is known to the electrical power distribution control entity that electrical power is consumed (at the first or second electrical power distribution station) by a specific user or by a group of users or by a specific (identifiable) device.

Additionally, it is advantageously possible according to the present invention that a user can choose his or her provider of electrical energy. It is possible according to the present invention that by choosing a preferred provider of electrical energy, this choice is transmitted to or stored at (or stored otherwise so as to be retrievable by) the electrical power distribution control entity (e.g. by transmitting the power request identifier either comprising this choice or by storing a profile information retrievable by the electrical power distribution control entity) such that this choice of the user is able to be respected.

The choice of the provider of electrical energy or electrical power can, e.g., include a choice (by the user) to use a specific energy mix assured by the provider of electrical energy, for example to use solely renewable sources of energy to produce the electrical power and/or to use solely renewable sources of energy of newly built renewably power plants (e.g. wind mills) and/or to explicitly include or exclude nuclear power sources in the energy mix.

The present invention provides a nomadic and flexible usage of electrical energy independent from a fixed relationship between a given electrical power distribution station and a given network for the distribution of electrical power coupled to that electrical power distribution station.

In conventional energy networks or energy grids, there is a more or less fixed relationship between a given provider of electrical energy and a given electrical power distribution station. For example, in a given home or a given office building, a given electrical energy meter (out of typically a plurality of electrical meters installed in the home or building and related to different owners and/or tenants in the home or building) is associated with a contract having as contract parties
a customer (especially the owner of the building and/or a tenant etc.), requiring electrical energy, and
a given provider of electrical energy.
   Any power consumption of electrical energy provided by an electrical power point connected with that given electrical energy meter is necessarily provided by that specific provider of electrical energy and billed to the other contracting party (i.e. the owner and/or tenant). Of course, it might be possible to switch the provider of electrical energy associated with that specific electrical energy meter (or home or office building) but this usually requires a time consuming procedure including compliance with cancellation periods for a given electrical power provision contract or the like. Usually, such a change is not possible within minutes or even hours, but rather maybe within weeks, months or even a year or a plurality of years. But even in case such a switch would be possible quickly, it would just be a switch in the sense that the electrical energy consumed at any electrical power point connected with that given electrical energy meter is necessarily provided by a specific provider and billed to the specific (predefined) customer (especially the owner of the home or building and/or a tenant).

According to the present invention, it is possible to easily and quickly change
the provider of electrical energy at a given electrical power distribution station as well as
the customer to whom that electrical energy is billed.
   For example, if a first home is usually served by a first provider of electrical energy and hosts a visitor having a second home usually served by a second provider of electrical energy, it is possible according to the present invention that that visitor—while being at the first home and while consuming electrical power—is served and billed by the second provider of electrical energy. This is because the first home (or first electrical power distribution station) is associated with a first electrical power distribution identifier and the second home (or second electrical power distribution station) is associated with a second electrical power distribution identifier. During the time of visit of the visitor at the first home (or first electrical power distribution station), it is indicated that a specific consumption of energy is attributed to the visitor and therefore billed by the second provider of electrical power not to the owner of the first home but to the visitor. Additionally, the present invention provides that the user or customer (i.e. in this example the visitor) is related to a power request identifier such that by communication (or transmitting) both the power request identifier and the second electrical power distribution identifier to the electrical power distribution control entity, the electrical power consumption (obtained from or at the first home, i.e. from the first electrical power distribution station) is assigned (and hence metered and billed) to the visitor on behalf of the second provider of electrical power.

The transmission of the power request identifier to the electrical power distribution control entity can advantageously be performed either
prior to the beginning of the electrical power consumption, or
at the beginning of the electrical power consumption (i.e. while the electrical power consumption has already started), and/or
continuously during the electrical power consumption (i.e. with a predetermined frequency and/or for a predetermined amount of electrical energy).

It is preferred according to the present invention that the amount of electrical power requested/to be requested is transmitted together with the power request identifier, preferably prior to the beginning of the electrical power consumption or at the beginning of the electrical power consumption and/or after the electrical power consumption.

According to the present invention, it is preferred that the power request identifier is related to the identity represented by an identification card selected from the group comprising a national or multinational identity card, a credit card, a subscriber identity module (SIM) card, universal subscriber identity module (USIM) card, and a prepaid card.

Thereby, it is advantageously possible according to the present invention that any identity provided by any card device or identification card is usable to identify the user and hence the electrical power consumption contract.

Furthermore, it is preferred according to the present invention that the power request identifier is a unique identifier.

By using a unique identifier, it is advantageously possible according to the present invention that an identification characteristic can be used to identify a user that is globally unique. Such a unique identifier could be called an International Energy Subscriber Identity (IESI) being associated with a user or an identity such as a credit card identity or a subscriber identity module (SIM) card identity or a universal subscriber identity module (USIM) card identity in a unique manner. The use of a unique identifier, especially a globally unique identifier, as the power request identifier enables expansion of the use of a system and a method according to the present invention to a multitude of countries because it is globally possible to identify a user or a device.

According to further preferred embodiments of the present invention, it is preferred
that the power request identifier comprises at least a first identifier part related to the user or to the group of users requesting at least temporarily electrical power from the first or second electrical power distribution station and/or
that the power request identifier comprises at least a second identifier part related to the device requesting at least temporarily electrical power from the first or second electrical power distribution station.

Thereby, it is advantageously possible to provide the possibility to flexibly relate the information of the electrical power distribution identifier with user information comprised by or contained in the power request identifier. For example, it is possible according to the present invention that the power request identifier comprises a first identifier part related (solely) to the user or to a group of users.

In case that the identification of the user is sufficient to be able to bill and meter a specific electrical power consumption, the use of the first identifier part in the power request identifier might be sufficient.
In another case, it might be required to know additionally the identity (or the kind) of the device consuming electrical energy (e.g. whether the device is an electric car or a washing machine or a refrigerator might have an impact on the tariff (and/or the applicable taxes or tax rates) to apply for a specific electrical power consumption) which means that the power request identifier not only comprises a first identifier part (identifying a user or a group of users) but also a second identifier part (identifying the device requiring or providing electrical power or identifying at least the kind of device requiring or providing electrical power). In still another case, it might be required to know (solely) the identity (or the kind) of the device consuming electrical energy which means that the power request identifier comprises the second identifier part (identifying the device requiring or providing electrical power or identifying at least the kind of device requiring or providing electrical power).

According to the present invention, it is furthermore also preferred that the first electrical power distribution identifier is assigned to a first electrical power provider, and wherein the second electrical power distribution identifier is assigned to a second electrical power provider.

Furthermore, it is preferred according to the present invention that the transmission of the first or second electrical power distribution identifier is realized by a mobile communication transmission line
between the user and the electrical power distribution control entity, and/or
between the device requiring or providing electrical power and the electrical power distribution control entity.

Thereby, it is easily possible according to the present invention to use established communication means to convey or transmit the relevant information for allowing for a nomadic use of electrical energy. Additionally, it is not necessary according to such a communication approach to replace or modify existing parts of the existing infrastructure for distribution of electrical energy, such as (fixed line or power line) communication lines parallel to an electrical energy distribution grid, which would be costly.

According to the present invention, it is preferred that information is exchanged directly between the user and/or the device on the one hand and the electrical power distribution control entity on the other hand using an information transmission route which differs from the power line between the electrical power distribution station used and the electrical power provider or the electrical power distribution control entity. This enables the use of the inventive system and method without the need for modifying existing electrical power supply infrastructure because the necessary information to be exchanged for the delivery of electrical power are transmitted without any interference to the electrical power distribution network. The only modification to be applied to the electrical power distribution infrastructure relates to the possibility to identify the electrical power distribution station. Presently, for example, every electrical power metering device defines a different electrical power distribution station which means that every power socket within a home or within an office can be used to consume electrical energy independently from the other power sockets within that home or office. In the context of the present invention, it is preferred to be able to apply a more fine-grained approach in consuming energy. For example, it might be advantageous to at least be able to distinguish the energy consumption in different rooms of a home, e.g. the kitchen, the living room or the garage (where the batteries of an electrically powered vehicle are loaded). It is advantageous according to the present invention to be able to differentiate an energy consumption between different rooms in a home, i.e. a power socket in the kitchen and a power socket in the garage are treated as different electrical power distribution stations, and thus having preferably also different electrical power distribution identifiers.

However, it is also possible and preferred according to the present invention that other communications channels are used (either instead of a mobile communication line or additionally to a mobile communication line), such as a fixed line telephone network and/or a powerline communication for the realization of the transmission of the first or second electrical power distribution identifier.

According to the present invention, it is furthermore preferred that the transmission to the electrical power distribution control entity includes the transmission of
an indication of the presumed quantity of the electrical power consumption and/or
an indication of the presumed consumption time of electrical power consumption, and/or
an indication of a profile information related to the user and/or related to the device requiring or providing electrical power, and/or
an indication of a charging history information related to the user and/or related to the device requiring or providing electrical power.

Thereby, it is advantageously possible to provide an enormous increase in flexibility in the use of electrical power generation resources vs. electrical power consumption which reduces capital spending for the provision of extra electrical power generation capacity for peak load.

For example, it is possible according to the present invention to indicate that a consumption of electrical energy is needed within a certain period of time but it might also be indicated that this power consumption is somewhat flexible so that it might be up to the electrical power provider to exactly define when to provide the electrical power. An example thereof might be a washing machine running during the night. The only requirement a user typically has is that the washing has occurred at a given time in the morning, e.g. 7 am or 8 am. This means that the actual delivery of electrical power to the washing machine could be synchronized with an increased availability of power (e.g. due to a stronger wind blowing at a site of a wind farm).

Another example is the charging of the batteries of an electrical vehicle. Dependent on the actual battery status of the electrical vehicle, it is possible according to the present invention to provide the indication to the electrical power distribution control entity that a certain amount of electrical energy is needed within the next 8 hours. This amount could be divided into a first amount that should be provided as quickly as possible (especially in case that the actually battery status of the electrical vehicle is such that the cruising range is inferior to a certain, especially user definably limit) and a second amount that is nice to have immediately but not necessary to be loaded immediately. Thereby, it is possible according to the present invention to assure that, e.g. in case of emergency, a minimum cruising range is always or almost always available and nevertheless assure that the energy delivery grid is not stressed unnecessarily. Of course, it is preferred according to the present invention that a pricing difference can be attached to a consumption of energy with a higher degree of flexibility (regarding the precise time of the consumption of energy) (typically lower prices) than with a lower degree of flexibility.

Additionally, it is preferred according to the present invention that such an indication of the presumed quantity and consumption time is transmitted in advance to the electrical power distribution control entity, i.e. without that the user or the device requiring electrical power being at a specific electrical power distribution station. This is useful in case that especially an electrical vehicle needs to be charged in a comparably small interval of time, e.g. during a longer trip exceeding the typical cruising range of the batteries of the electrical vehicle. In such a situation, a user could give information indicating that a specific filling station (determined to be able to be reached given the current battery status of the electrical vehicle and given the distance to that filling station) should be used to charge the batteries. That filling station might prepare such that the energy is actually ready (e.g. stored in an energy reservoir at the filling station or the like) at the moment the electrical vehicle arrives.

According to the present invention, it is advantageous that profile information is transmitted indicating a profile of the energy need, especially the profile with respect to the (timely) flexibility regarding the energy consumption. In case that the power request identifier comprises the second identifier part related to the device, it is advantageously possible according to the present invention to either transmit the profile information together with the second identifier part of the power request identifier or to refer (by the second identifier part) to profile information, e.g. stored at or retrievable by the electrical power distribution control entity. It is also possible and preferred according to the present invention to provide a set of profile information where a user determines whether a default profile information should be used in connection with a specific energy consumption event or a non-default profile information (e.g. in case that the washing machine necessarily needs to be finished as soon as it is possible (to the washing machine)). It is also possible that the device requiring electrical power transmits or selects the profile information, e.g. in case that a quick program is selected at the washing machine, the default profile information (associated to the washing machine electrical energy consumption) differs from the default profile information in case a normal program is selected.

The electrical power distribution control entity according to the present invention can, e.g., be a monitoring entity associated to a specific electrical power provider or acting for a plurality of electrical power provider. It is preferred according to the present invention that the electrical power distribution control entity administrates a plurality of assigned power request identifiers, especially IESIs. At the electrical power distribution control entity (or in another entity but assigned to the electrical power distribution control entity), profile information can be associated to a given power request identifier. In case that the power request identifier is device specific, i.e. the power request identifier differs (for a given user) between different devices, it is advantageously possible to provide fine-grained profile information. According to the present invention, it is furthermore preferred that the electrical power distribution control entity is an energy broker. In the context of the present invention, an energy broker interacts between different electrical power distribution control entities (of different electrical power providers) such that it is not necessary that each (electrical power distribution control entity of an) electrical power provider provides an interface to (the electrical power distribution control entities of) all electrical power providers.

The present invention also relates to a method for the delivery of electrical energy using at least a first electrical power distribution station, and a second electrical power distribution station,

wherein a first electrical power distribution identifier is assigned to the first electrical power distribution station, and wherein a second electrical power distribution identifier is assigned to the second electrical power distribution station,
wherein a power request identifier is assigned to at least one out of
a user or a group of users, and
a device requiring or providing electrical power,
   wherein an electrical power distribution control entity is used,
   wherein in case that electrical power is requested from the first electrical power distribution station, the first electrical power distribution identifier and the power request identifier are transmitted to the electrical power distribution control entity, and
   wherein in case that electrical power is requested from the second electrical power distribution station, the second electrical power distribution identifier and the power request identifier are transmitted to the electrical power distribution control entity.

According to the present invention, it is advantageously possible to flexibly use electrical energy independently from the location of usage of the electrical power.

Also with regard to the inventive method, it is preferred according to the present invention that the power request identifier comprises
at least a first identifier part related to the user or to the group of users requesting at least temporarily electrical power from the first or second electrical power distribution station and/or
at least a second identifier part related to the device requesting at least temporarily electrical power from the first or second electrical power distribution station.

Thereby, it is advantageously possible to provide the possibility to flexibly relate to the information of the electrical power distribution identifier with a useful information comprised by or contained in the power request identifier.

Also with regard to the inventive method, it is preferred according to the present invention that the first electrical power distribution identifier is assigned to a first electrical power provider, and wherein the second electrical power distribution identifier is assigned to a second electrical power provider.

Still furthermore, it is preferred—also with respect to the inventive system according to the present invention—that the transmission of the first or second electrical power distribution identifier is realized by means of a mobile communication transmission line between the user and the electrical power distribution control entity.

Also with regard to the inventive method, it is preferred according to the present invention that the transmission to the electrical power distribution control entity includes the transmission of:
an indication of the presumed quantity of the electrical power consumption and/or
an indication of the presumed consumption time of electrical power consumption, and/or
an indication of a profile information related to the user and/or related to the device requiring or providing electrical power, and/or
an indication of a charging history information related to the user and/or related to the device requiring or providing electrical power.

Additionally, the present invention relates to a program comprising a computer readable program code for executing a method according to the present invention or for configuring or controlling a system according to the present invention.

Furthermore, the present invention relates to a computer program product comprising a computer-readable storage medium having computer-readable program instructions embodied in the medium for executing a method according to the present invention or for configuring or controlling a system according to the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

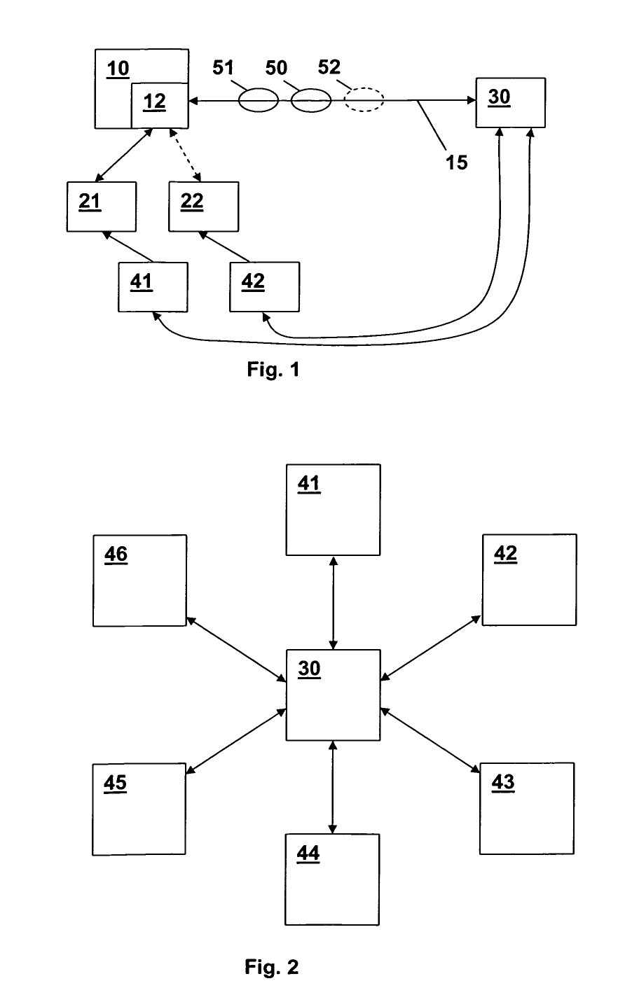

In FIG. 1, an illustration of a system according to an embodiment of the present invention is schematically shown. A user 10 has a device 12 that is requiring or providing electrical power such as a washing machine, the battery of an electrical vehicle, the charger of a mobile telephone or the like. The system further provides a first electrical power distribution station 21 and a second electrical power distribution station 22. The device 12 that is requiring or providing electrical power can either be coupled to the first electrical power distribution station 21 (indicated in FIG. 1 by a drawn through arrow) or to the second electrical power distribution station 22 (indicated in FIG. 1 by a dashed arrow).

By a communication line 15 between either the user 10 and an electrical power distribution control entity 30 or between the device 12 that is requiring or providing electrical power and the electrical power distribution control entity 30, an exchange of information occurs such that a first electrical power distribution identifier 51, associated or assigned to the first electrical power distribution station 21, (in case that the device 12 is coupled to the first electrical power distribution station 21) or a second electrical power distribution identifier 52, associated or assigned to the second electrical power distribution station 22, (in case that the device 12 is coupled to the second electrical power distribution station 22) is transmitted to the electrical power distribution control entity 30.

During this transmission of information, also a power request identifier 50 is transmitted to the electrical power distribution control entity 30. The power request identifier 50 comprises
a first identifier part related to the user 10 and/or
a second identifier part related to the device 12 that is requiring or providing electrical power.

By transmitting the power request identifier 50 and the electrical power distribution identifier 51, 52, it is advantageously possible according to the present invention to allow for a higher degree of flexibility in the usage of electrical energy, especially for a nomadic use of electrical power.

According to one embodiment of a system according to the present invention, the electrical power distribution control entity 30 is independent from the electrical power providers and has a broker functionality. This is schematically shown in FIG. 2, where the electrical power distribution control entity 30 provides an interface to a number of electrical power providers, such as a first electrical power provider 41, a second electrical power provider 42, a third electrical power provider 43, a fourth electrical power provider 44, a fifth electrical power provider 45, and a sixth electrical power provider 46.

This interface is also represented in FIG. 1, where the communication between the user 10 and/or the device 12 that is requiring or providing electrical power with the electrical power distribution control entity 30 (via the communication line 15) triggers a flow of information between the electrical power distribution control entity 30 and one of the electrical power providers 41, 42.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

1-17. (canceled)

18. A system for deliver of electrical energy, the system comprising:
a first electrical power distribution station assigned a first electrical power distribution identifier;
a second electrical power distribution station assigned a second electrical power distribution identifier; and
an electrical power distribution control entity configured to receive, when electrical power is requested from the first electrical power distribution station, the first electrical power distribution identifier and power request identifier, and configured to receive, when electrical power is requested from the second electrical power distribution station, the second electrical power distribution identifier and the power request identifier;
wherein the power request identifier is assigned to at least one of:
a user or a group of users; and
a device configured to require or provide electrical power.

19. The system of claim 18, wherein the power request identifier corresponds to an identify represented by an identification card selected from the group consisting of: a national card, a multinational identity card, a credit card, a subscriber identity module (SIM) card, a universal subscriber identity module (USIM) card, and a prepaid card.

20. The system of claim 18, wherein the power request identifier is a unique identifier.

21. The system of claim 18, wherein the power request identifier comprises:
an identifier part related to the user or to the group of users requesting power.

22. The system of claim 18, wherein the power request identifier comprises:
an identifier part related to the device requesting power.

23. The system of claim 18, wherein the first electrical power distribution identifier corresponds to a first electrical power provider and the second electrical power distribution identifier corresponds to a second electrical power provider.

24. The system of claim 18, wherein the electrical power distribution identifier is received by the electrical power distribution control entity via a mobile communication transmission line, wherein the mobile communication transmission line is at least one of:
between the user or a user of the group of users requesting power and the electrical power distribution control entity; and
between the device requesting power and the electrical power distribution control entity.

25. The system of claim 18, wherein the power request includes at least one of:
an indication of a quantity of electrical power consumption;
an indication of a consumption tune of electrical power consumption;
an indication of profile information related to at least one of the user or the group of users or the device; and
an indication of charging history information related to at least one of the user or the group of users or the device.

26. The system of claim 18, wherein the electrical power distribution control entity is an energy broker.

27. A method for delivery of electrical energy using at least a first electrical power distribution station corresponding to a first electrical power distribution identifier and a second electrical power distribution station corresponding to a second electrical power distribution identifier, the method comprising:
receiving, by an electrical power distribution control entity, when electrical power is requested from the first electrical power distribution station, the first electrical power distribution identifier and power request identifier; and
receiving, by the electrical power distribution control entity, when electrical power is requested from the second electrical power distribution station, the second electrical power distribution identifier and the power request identifier;
wherein the power request identifier is assigned to at least one of:
a user or a group of users; and
a device configured to require or provide electrical power.

28. The method of claim 27, wherein the power request identifier comprises:
an identifier part related to the user or to the group of users requesting power.

29. The method of claim 27, wherein the power request identifier comprises:
an identifier part related to the device requesting power.

30. The method of claim 27, wherein the first electrical power distribution identifier corresponds to a first electrical power provider and the second electrical power distribution identifier corresponds to a second electrical power provider.

31. The method of claim 27, wherein the electrical power distribution identifier is received by the electrical power distribution control entity via a mobile communication transmission line between the user or a user of the group of users requesting power and the electrical power distribution control entity.

32. The method of claim 27, wherein the power request includes at least one of:
an indication of a quantity of electrical power consumption;
an indication of a consumption time of electrical power consumption;
an indication of profile information related to at least one of the user or the group of users or the device; and
an indication of charging history information related to at least one of the user or the group of users or the device.

33. A non-transitory computer-readable medium, part of an electrical power distribution control entity, having processor-executable instructions stored thereon for delivery of electrical energy using at least a first electrical power distribution station corresponding to a first electrical power distribution identifier and a second electrical power distribution station corresponding to a second electrical power distribution identifier, the processor-executable instructions comprising instructions for:
receiving, by an electrical power distribution control entity, when electrical power is requested from the first electrical power distribution station, the first electrical power distribution identifier and power request identifier; and
receiving, by the electrical power distribution control entity, when electrical power is requested from the second electrical power distribution station, the second electrical power distribution identifier and the power request identifier;
wherein the power request identifier is assigned to at least one of:
a user or a group of users; and
a device configured to require or provide electrical power.
